(19) United States
(12) Patent Application Publication
(10) Pub. No.: US 2008/0171815 A1
(43) Pub. Date: Jul. 17, 2008

(54) Pigmented Inkjet Ink With A Polymeric Dispersant Containing A Long Aliphatic Chain (Meth)Acrylate

(75) Inventors: Lambertus Groenendaal, Sinaai (BE); Geert Deroover, Lier (BE)

Correspondence Address: AGFA;c/o KEATING & BENNETT, LLP, 8180 GREENSBORO DRIVE, SUITE 850, MCLEAN, VA, 22102, US

(73) Assignee: AGFA GRAPHICS NV, Mortsel (BE)

(21) Appl. No.: 11/908,344

(22) PCT Filed: Mar. 31, 2006
(86) PCT No.: PCT/EP2006/061219

§ 371 Date: Sep. 11, 2007

Related U.S. Application Data
(60) Provisional application No. 60/687,044, filed on Jun. 3, 2005.

(30) Foreign Application Priority Data
Apr. 20, 2005 (EP) 05103161.5

(51) Int. Cl. C09D 11/10

(52) U.S. Cl. 524/90; 524/599

(57) ABSTRACT

A pigmented inkjet ink comprising a pigment and a polymeric dispersant wherein the polymeric dispersant is a statistical copolymer comprising between 3 and 11 mol % of a long aliphatic chain (meth)acrylate wherein the long aliphatic chain contains at least 10 carbon atoms.

### CROSS-REFERENCE TO RELATED APPLICATIONS

This application is a 371 of PCT/EP2006/061219, filed Mar. 31, 2006. This application claims the benefit of U.S. Provisional Application No. 60/687,044, filed Jun. 3, 2005, which is incorporated by reference. In addition, this application claims the benefit of European Application No. 05103161.5, filed Apr. 20, 2005, which is also incorporated by reference.

### BACKGROUND OF THE INVENTION

1. Field of the Invention

The present invention relates to stable pigmented inkjet inks with a polymeric dispersant containing a long chain (meth)acrylate.

2. Description of the Related Art

Pigment dispersions are made using a dispersant. A dispersant is a substance for promoting the formation and stabilization of a dispersion of pigment particles in a dispersion medium. Dispersants are generally surface-active materials having an anionic, cationic, or non-ionic structure. The presence of a dispersant substantially reduces the required dispersing energy. Dispersed pigment particles may have a tendency to re-agglomerate after the dispersing operation due to mutual attraction forces. The use of dispersants also counteracts this re-agglomeration tendency of the pigment particles.

The dispersant has to meet particularly high requirements when used for inkjet inks. Inadequate dispersing manifests itself as increased viscosity in liquid systems, loss of brilliance and/or hue shifts. Moreover, particularly good dispersion of the pigment particles is required to ensure unimpeded passage of the pigment particles through the nozzles of the print head which are usually only a few micrometers in diameter. In addition, pigment particle agglomeration and the associated blockage of the printer nozzles has to be avoided in the standby periods of the printer.

Polymeric dispersants contain in one part of the molecule so-called anchor groups, which adsorb onto the pigments to be dispersed. In a spatially separate part of the molecule, polymeric dispersants have a polymer chain which sticks out and whereby pigment particles are made compatible with the dispersion medium, i.e., stabilized.

The properties of polymeric dispersants depend on both the nature of the monomers and their distribution in the polymer. Polymeric dispersants obtained by randomly polymerizing monomers (e.g., monomers A and B polymerized into ABBAABAB) or by polymerizing alternating monomers (e.g., monomers A and B polymerized into ABABABAB) generally result in a poor dispersion stability. Improvements in dispersion stability were obtained using graft copolymer and block copolymer dispersants.

Graft copolymer dispersants consist of a polymeric backbone with side chains attached to the backbone. CA 2157361 (DU PONT) discloses pigment dispersions made by using a graft copolymer dispersant with a hydrophobic polymeric backbone and hydrophilic side chains. Other graft copolymer dispersants are disclosed in U.S. Pat. No. 6,652,634 (LEXMARK), U.S. Pat. No. 6,521,715 (DU PONT), and U.S. 2004/0102541 (LEXMARK).

Block copolymer dispersants containing hydrophobic and hydrophilic blocks have been disclosed in numerous inkjet ink patents. U.S. Pat. No. 5,859,113 (DU PONT) discloses an AB block copolymer dispersant with a polymeric A segment of polymerized glycidyl (meth)acrylate monomers reacted with an aromatic or aliphatic carboxylic acid, and a polymeric B segment of polymerized alkyl (meth)acrylate monomers having 1-12 carbon atoms in the alkyl group, hydroxy alkyl (meth)acrylate monomers. U.S. Pat. No. 6,413,306 (DU PONT) discloses ABC block copolymer dispersants with a polymeric A segment of polymerized alkyl (meth)acrylate monomers having 1-12 carbon atoms in the alkyl group, aryl (meth)acrylate monomers, cycloalkyl (meth)acrylate monomers, a polymeric B segment of polymerized alkyl amino alkyl(meth)acrylate monomers with a quaternized alkyl group, and a polymeric C segment of polymerized hydroxyalkyl (meth)acrylate monomers.

The design of polymeric dispersants for inkjet inks is discussed in SPINELLI, Harry J.; Polymeric Dispersants in Ink Jet Technology, Advanced Materials; 1998; vol. 10, no. 15; pp. 1215-1218.

A wide variety of polymeric dispersants has been proposed, but the dispersion stability of pigments, especially in inkjet inks, still needs further improvement. For consistent image quality, the inkjet ink requires a dispersion stability capable of dealing with high temperatures (above 60° C.) during transport of the ink to a customer and changes in the dispersion medium of the inkjet ink during use, for example, evaporation of water and increasing concentrations of humectant. It is highly desirable to be able to manufacture such stable pigmented inkjet inks using a polymeric dispersant obtained by a simple synthesis, i.e., by randomly polymerizing monomers.

### SUMMARY OF THE INVENTION

In order to overcome the problems discussed above, preferred embodiments of the present invention provide pigmented inkjet inks using a polymeric dispersant obtained by simple synthesis, exhibiting high dispersion stability, and producing images of high image quality with a high optical density.

Further advantages of various preferred embodiments of the present invention will become apparent from the following description.

It has been surprisingly discovered that pigmented inkjet inks with high stability and high optical density were obtained when the statistical copolymers contained a certain concentration of long aliphatic chain (meth)acrylate.

Preferably, preferred embodiments of the present invention provide a pigmented inkjet ink including a pigment and a polymeric dispersant wherein the polymeric dispersant is a statistical copolymer having between 3 mol % and 11 mol % of a long aliphatic chain (meth)acrylate, wherein the long aliphatic chain contains at least 10 carbon atoms.

Other features, elements, processes, steps, characteristics and advantages of the present invention will become more apparent from the following detailed description of preferred embodiments of the present invention.

### DETAILED DESCRIPTION OF PREFERRED EMBODIMENTS

### Definitions

The term “dye”, as used in the following description of preferred embodiments of the present invention, means a colorant having a solubility of 10 mg/L or more in the medium in which it is applied and under the ambient conditions pertaining thereto.

The term “pigment” is defined in DIN 55943, herein incorporated by reference, as an inorganic or organic, chromatic or achromatic coloring agent that is practically insoluble in the application medium under the pertaining ambient conditions, hence having a solubility of less than 10 mg/L therein.

The term “dispersion”, as used in the following description of preferred embodiments of the present invention, means an intimate mixture of at least two substances, one of which, called the dispersed phase or colloid, is uniformly distributed in a finely divided state through the second substance, called the dispersion medium.

The term “polymeric dispersant”, as used in the following description of preferred embodiments of the present invention, means a substance for promoting the formation and stabilization of a dispersion of a substance in a dispersion medium.

The term “copolymer”, as used in the following description of preferred embodiments of the present invention, means a macromolecule in which two or more different species of monomers are incorporated into a polymer chain.

The term “statistical copolymer”, as used in the following description of preferred embodiments of the present invention, means a copolymer obtained by randomly polymerizing monomers, e.g., monomers A and B polymerized into ABBAABAB.

The term “block copolymer”, as used in the following description of preferred embodiments of the present invention, means a copolymer in which the monomers occur in relatively long alternate sequences in a chain.

The term “spectral separation factor” as used in the following description of preferred embodiments of the present invention means the value obtained by calculating the ratio of the maximum absorbance Amax (measured at wavelength λmax) over the absorbance Aref determined at a reference wavelength λref.

The abbreviation “SSF” is used in the following description of preferred embodiments of the present invention for spectral separation factor.

The term “alkyl” means all variants possible for each number of carbon atoms in the alkyl group, i.e., for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl, and 2-methyl-butyl, etc.

The term “substituted” as used in the following description of the preferred embodiments of the present invention means that one or more of the carbon atoms and/or that a hydrogen atom of one or more of carbon atoms in an aliphatic group, an aromatic group, or an alicyclic hydrocarbon group are replaced by an oxygen atom, a nitrogen atom, a halogen atom, a silicon atom, a sulphur atom, a phosphorous atom, a selenium atom, or a tellurium atom. Such substituents include hydroxyl groups, ether groups, carboxylic acid groups, ester groups, amide groups, and amine groups.

### Pigmented Inkjet Ink

The pigmented inkjet ink according to a preferred embodiment of the present invention contains at least three components: (i) a pigment, (ii) a polymeric dispersant, and (iii) a dispersion medium.

The pigmented inkjet ink according to a preferred embodiment of the present invention may further contain at least one surfactant.

The pigmented inkjet ink according to a preferred embodiment of the present invention may further contain at least one biocide.

The pigmented inkjet ink according to a preferred embodiment of the present invention may further contain at least one pH adjuster.

The pigmented inkjet ink according to a preferred embodiment of the present invention may contain at least one humectant to prevent the clogging of the nozzle due to its ability to slow down the evaporation rate of ink.

The viscosity of the pigmented inkjet ink according to a preferred embodiment of the present invention is preferably lower than 100 mPa·s, more preferably lower than 30 mPa·s, and most preferably lower than 10 mPa·s at a shear rate of 100 s⁻¹ and a temperature between 20° C. and 110° C.

The pigmented inkjet ink according to a preferred embodiment of the present invention is preferably an aqueous or solvent based pigmented inkjet ink.

The pigmented inkjet ink according to a preferred embodiment of the present invention may be radiation curable and may contain monomers, oligomers, and/or prepolymers possessing different degrees of functionality. A mixture including combinations of mono-, di-, tri- and higher functionality monomers, oligomers, or prepolymers may be used. A catalyst called a photo-initiator for initiating the polymerization reaction may be included in the radiation curable pigmented inkjet ink.

### Pigments

The pigment used in the pigmented inkjet ink according to a preferred embodiment of the present invention may be black, cyan, magenta, yellow, red, orange, violet, blue, green, brown, mixtures thereof, and the like.

The pigment may be chosen from those disclosed by HERBST, W. et al.; Industrial Organic Pigments, Production, Properties, Applications; 2nd edition; vch, 1997.

Particular preferred pigments are C.I. Pigment Yellow 1, 3, 10, 12, 13, 14, 17, 55, 65, 73, 74, 75, 83, 93, 109, 111, 120, 128, 138, 139, 150, 151, 154, 155, 180, 185, and 213.

Particular preferred pigments are C.I. Pigment Red 17, 22, 23, 41, 48:1, 48:2, 49:1, 49:2, 52:1, 57:1, 81:1, 81:3, 88, 112, 122, 144, 146, 149, 169, 170, 175, 176, 184, 185, 188, 202, 206, 207, 210, 216, 221, 248, 251, and 264.

Particular preferred pigments are C.I. Pigment Violet 1, 2, 19, 23, 32, 37, and 39.

Particular preferred pigments are C.I. Pigment Blue 15:1, 15:2, 15:3, 15:4, 16, 56, 61, and (bridged) aluminum phthalocyanine pigments.

Particular preferred pigments are C.I. Pigment Orange 5, 13, 16, 34, 40, 43, 59, 66, 67, 69, 71, and 73.

Particular preferred pigments are C.I. Pigment Green 7 and 36.

Particular preferred pigments are C.I. Pigment Brown 6 and 7.

Particular preferred pigments are C.I. Pigment White 6.

Particular preferred pigments are C.I. Pigment Metal 1, 2, and 3.

For the black ink, suitable pigment materials include carbon blacks such as Regal™ 400R, Mogul™ L, Elftex™ 320 from Cabot Co., or Carbon Black FW18, Special Black™ 250, Special Black™ 350, Special Black™ 550, Printex™ 25, Printex™ 35, Printex™55, Printex™ 90, Printex™ 150T from DEGUSSA Co., MA8 from MITSUBISHI CHEMICAL Co., and C.I. Pigment Black 7 and C.I. Pigment Black 11.

The pigment particles in the pigmented inkjet ink should be sufficiently small to permit free flow of the ink through the inkjet printing device, especially at the ejecting nozzles. It is also desirable to use small particles for maximum color strength and to slow down sedimentation.

The average particle size of the pigment in the pigmented inkjet ink should be between 0.005 μm and 15 μm. Preferably, the average pigment particle size is between 0.005 μm and 5 μm, more preferably between 0.005 μm and 1 μm, particularly preferably between 0.005 μm and 0.3 μm, and most preferably between 0.040 μm and 0.150 μm. Larger pigment particle sizes may be used as long as the objectives of the present invention are achieved.

The pigment is used in the pigmented inkjet ink in an amount of 0.1 wt % to 20 wt %, preferably 1 wt % to 10 wt % based on the total weight of the pigmented inkjet ink.

### Polymeric Dispersant

The polymeric dispersant used in the pigmented inkjet ink according to a preferred embodiment of the present invention is a copolymer including between 3 mol % and 11 mol % of a long aliphatic chain (meth)acrylate wherein the long aliphatic chain contains at least 10 carbon atoms.

The long aliphatic chain (meth)acrylate contains 10 to 18 carbon atoms. The long aliphatic chain (meth)acrylate is preferably decyl (meth)acrylate.

The polymeric dispersant used in the pigmented inkjet ink according to a preferred embodiment of the present invention can be prepared with a simple controlled polymerization of a mixture of monomers and/or oligomers including between 3 mol % and 11 mol % of a long aliphatic chain (meth)acrylate wherein the long aliphatic chain contains at least 10 carbon atoms.

The polymeric dispersant used in the pigmented inkjet ink according to a preferred embodiment of the present invention includes preferably at least 2 other monomers and/or oligomers.

The polymeric dispersant used in the pigmented inkjet ink according to a preferred embodiment of the present invention preferably has an average molecular weight Mw smaller than 100000, more preferably smaller than 50000 and most preferably smaller than 30000.

Other Monomers and/or Oligomers

The monomers and/or oligomers used to prepare the polymeric dispersant used in the pigmented inkjet ink according to a preferred embodiment of the present invention can be any monomer and/or oligomer found in the Polymer Handbook, Vol. 1+2, 4th edition; Edited by J. BRANDRUP et al.; Wiley-Interscience, 1999.

Suitable examples of monomers include: acrylic acid, methacrylic acid, maleic acid, acryloyloxybenzoic acid, and methacryloyloxybenzoic acid (or their salts), maleic anhydride; alkyl(meth)acrylates (linear, branched and cycloalkyl) such as methyl(meth)acrylate, n-butyl(meth)acrylate, tert-butyl(meth)acrylate, cyclohexyl(meth)acrylate and 2-ethylhexyl(meth)acrylate; aryl(meth)acrylates such as benzyl(meth)acrylate and phenyl(meth)acrylate; hydroxyalkyl(meth)acrylates such as hydroxyethyl(meth)acrylate and hydroxypropyl(meth)acrylate; (meth)acrylates with other types of functionalities (e.g., oxirane, amino, fluoro, polyethylene oxide, phosphate-substituted) such as glycidyl (meth)acrylate, dimethylaminoethyl(meth)acrylate, trifluoroethyl acrylate, methoxypolyethyleneglycol (meth)acrylate and tripropyleneglycol(meth)acrylate phosphate; allyl derivatives such as allyl glycidyl ether; styrenics such as styrene, 4-methylstyrene, 4-hydroxystyrene, and 4-acetoxystyrene; (meth)acrylonitrile; (meth)acrylamides (including N-mono and N,N-disubstituted) such as N-benzyl (meth)acrylamide; maleimides such as N-phenyl maleimide, N-benzyl maleimide, and N-ethyl maleimide; vinyl derivatives such as vinylcaprolactam, vinylpyrrolidone, vinylimidazole, vinylnaphthalene, and vinyl halides; vinylethers such as vinylmethyl ether; and vinylesters of carboxylic acids such as vinylacetate and vinylbutyrate.

The polymeric dispersant used in the pigmented inkjet ink according to a preferred embodiment of the present invention includes preferably at least 25 mol % n-butyl (meth)acrylate.

The polymeric dispersant used in the pigmented inkjet ink according to a preferred embodiment of the present invention includes preferably at least 25 mol % (meth)acrylic acid.

The polymeric dispersant used in the pigmented inkjet ink according to a preferred embodiment of the present invention includes preferably at least 5 mol % methyl (meth)acrylate.

The polymeric dispersant used in the pigmented inkjet ink according to a preferred embodiment of the present invention preferably has Mn smaller than 10000.

An example of a commercially available polymeric dispersant suitable for the pigmented inkjet ink according to a preferred embodiment of the present invention is EDAPLAN™ 482 available from MÜNZING CHEMIE, which contains about 6 mol % of a long aliphatic chain (meth)acrylate.

The polymeric dispersant is used in the pigmented inkjet ink in an amount of 5 wt % to 200 wt %, preferably 10 wt % to 100 wt % based on the weight of the pigment.

### Dispersion Medium

The dispersion medium used in the pigmented inkjet ink according to a preferred embodiment of the present invention is a liquid. The dispersion medium may consist of water and/or organic solvent(s). Preferably the dispersion medium is water.

If the pigmented inkjet ink is a radiation curable pigmented inkjet ink, water and/or organic solvent(s) are replaced by one or more monomers and/or oligomers to obtain a liquid dispersion medium. Sometimes, it can be advantageous to add a small amount of an organic solvent to improve the dissolution of the dispersant. The content of organic solvent should be lower than 20 wt % based on the total weight of the pigmented inkjet ink.

Suitable organic solvents include alcohols, aromatic hydrocarbons, ketones, esters, aliphatic hydrocarbons, higher fatty acids, carbitols, cellosolves, higher fatty acid esters. Suitable alcohols include, methanol, ethanol, propanol and 1-butanol, 1-pentanol, 2-butanol, t.-butanol. Suitable aromatic hydrocarbons include toluene, and xylene. Suitable ketones include methyl ethyl ketone, methyl isobutyl ketone, 2,4-pentanedione and hexafluoroacetone. Also glycol, glycolethers, N-methylpyrrolidone, N,N-dimethylacetamid, N,N-dimethylformamid may be used.

### Surfactant

The pigmented inkjet ink according to a preferred embodiment of the present invention may contain at least one surfactant. The surfactant(s) can be anionic, cationic, non-ionic, or zwitter-ionic and are usually added in a total quantity less than 20 wt % based on the total weight of the pigmented inkjet ink and particularly in a total less than 10 wt % based on the total weight of the pigmented inkjet ink.

Suitable surfactants for the pigmented inkjet ink according to a preferred embodiment of the present invention include fatty acid salts, ester salts of a higher alcohol, alkylbenzene sulphonate salts, sulphosuccinate ester salts and phosphate ester salts of a higher alcohol (for example, sodium dodecylbenzenesulphonate and sodium dioctylsulphosuccinate), ethylene oxide adducts of a higher alcohol, ethylene oxide adducts of an alkylphenol, ethylene oxide adducts of a polyhydric alcohol fatty acid ester, and acetylene glycol and ethylene oxide adducts thereof (for example, polyoxyethylene nonylphenyl ether, and SURFYNOL™ 104, 104H, 440, 465 and TG available from AIR PRODUCTS & CHEMICALS INC.).

### Biocides

Suitable biocides for the pigmented inkjet ink of a preferred embodiment of the present invention include sodium dehydroacetate, 2-phenoxyethanol, sodium benzoate, sodium pyridinethion-1-oxide, ethyl p-hydroxybenzoate, and 1,2-benzisothiazolin-3-one and salts thereof.

Preferred biocides are Bronidox™ available from HENKEL and Proxel™ GXL available from ZENECA COLORS.

A biocide is preferably added in an amount of 0.001 wt % to 3 wt %, more preferably 0.01 wt % to 1.00 wt %, each based on the total weight of the pigmented inkjet ink.

pH adjusters

The pigmented inkjet ink according to a preferred embodiment of the present invention may contain at least one pH adjuster. Suitable pH adjusters include NaOH, KOH, NEt₃, NH₃, HCl, HNO₃, H₂SO₄ and (poly)alkanolamines such as triethanolamine and 2-amino-2-methyl-1-propaniol. Preferred pH adjusters are NaOH and H₂SO₄.

### Humectants

Suitable humectants include triacetin, N-methyl-2-pyrrolidone, glycerol, urea, thiourea, ethylene urea, alkyl urea, alkyl thiourea, dialkyl urea and dialkyl thiourea, diols, including ethanediols, propanediols, propanetriols, butanediols, pentanediols, and hexanediols; glycols, including propylene glycol, polypropylene glycol, ethylene glycol, polyethylene glycol, diethylene glycol, tetraethylene glycol, and mixtures and derivatives thereof. Preferred humectants are glycerol and 1,2-hexanediol. The humectant is preferably added to the inkjet ink formulation in an amount of 0.1 wt % to 20 wt % of the formulation, more preferably 0.1 wt % to 10 wt % of the formulation, and most preferably approximately 4.0 to 6.0 wt %.

### Preparation of a Pigmented Inkjet Ink

The pigmented inkjet ink according to a preferred embodiment of the present invention may be prepared by precipitating or milling the pigment in the dispersion medium in the presence of the polymeric dispersant.

Mixing apparatuses may include a pressure kneader, an open kneader, a planetary mixer, a dissolver, and a Dalton Universal Mixer. Suitable milling and dispersion apparatuses are a ball mill, a pearl mill, a colloid mill, a high-speed disperser, double rollers, a bead mill, a paint conditioner, and triple rollers. The dispersions may also be prepared using ultrasonic energy.

Methods for preparation of very fine dispersions of pigments are disclosed in e.g. U.S. Pat. No. 5,6791,38 (KODAK), U.S. Pat. No. 5,538,548 (BROTHER), U.S. Pat. No. 5,443,628 (VIDEOJET SYSTEMS), U.S. Pat. No. 4,836,852 (OLIVETTI), U.S. Pat. No. 5,285,064 (EXTREL), U.S. Pat. No. 5,184,148 (CANON), and U.S. Pat. No. 5,223,026 (XEROX).

### Spectral Separation Factor

The spectral separation factor SSF was found to be an excellent measure to characterize a pigmented inkjet ink, as it takes into account properties related to light-absorption (e.g., wavelength of maximum absorbance λmax, shape of the absorption spectrum, and absorbance-value at λmax) as well as properties related to the dispersion quality and stability.

A measurement of the absorbance at a higher wavelength gives an indication on the shape of the absorption spectrum. The dispersion quality can be evaluated based on the phenomenon of light scattering induced by solid particles in solutions. When measured in transmission, light scattering in pigment inks may be detected as an increased absorbance at higher wavelengths than the absorbance peak of the actual pigment. The dispersion stability can be evaluated by comparing the SSF before and after a heat treatment of, e.g., a week at 80° C.

The spectral separation factor SSF of the ink is calculated by using the data of the recorded spectrum of an ink solution or a jetted image on a substrate and comparing the maximum absorbance to the absorbance at a reference wavelength. The spectral separation factor is calculated as the ratio of the maximum absorbance Amax over the absorbance Aref at a reference wavelength.

$$SSF = \frac{{A}_{max}}{{A}_{ref}}$$

The SSF is an excellent tool to design inkjet ink sets with a large color gamut. Often, inkjet ink sets are now commercialized, wherein the different inks are not sufficiently matched with each other. For example, the combined absorption of all inks does not give a complete absorption over the whole visible spectrum, e.g., “gaps” exist between the absorption spectra of the colorants. Another problem is that one ink might be absorbing in the range of another ink. The resulting color gamut of these inkjet ink sets is low or mediocre.

### EXAMPLES

### Materials

All materials used in the following examples were readily available from standard sources such as Aldrich Chemical Co. (Belgium) and Acros (Belgium) unless otherwise specified. The water used was deionized water.

Inkjet Magenta™ EO2VP2621 is C.I. Pigment Red 122 available from CLARIANT.

AA is acrylic acid from Acros.
MAA is methacrylic acid from Acros.
MMA is methyl methacrylate from Acros.
BnMA is benzylmethacrylate from Acros.
BuA is n-butylacrylate from Acros.
BuMA is n-butyl methacrylate from Acros.
MPEGMA is an abbreviation for methoxypolyethyleneglycol 350 methacrylate from Cognis Performance Chemicals under the tradename of Bisomer™ MPEG 350MA
EHA is 2-ethyl hexyl acrylate from Acros.
STY is styrene from Acros.
LCMA is decyl methacrylate from Fluka.
WAKO™ V601 is the initiator 2-(1-Methoxycarbonyl-1-methyl-ethyl azo)-2-methyl-propionic acid methyl ester from Wako.
IPA is isopropanol from Lamers & Pleuger.
α-MSTY is α-methylstyrene dimer from Goi Chemical Co.
C.I. Pigment Blue 15:3 is SunFast™ Blue 15:3 from Sun Chemical Corp.
C.I. Pigment Red 122 is Ink Jet Magenta E02VP2621 from Clariant.

### C.I. Pigment Yellow 74 is Hansa Briljant™ Yellow 1 5GX 03.

C.I. Pigment Black 7 is Printex™ 90 from Degussa.
Joncryl™ 8078 from Johnson Polymer.
Edaplan™ 482 from Munzing Chemie.

### Measurement Methods

### 1. SSF Factor

The spectral separation factor SSF was calculated as the ratio of the maximum absorbance Amax (measured at wavelength λmax) over the absorbance Aref determined at the reference wavelength of λmax+200 nm.

The absorbance was determined in transmission with a Hewlett Packard 8452A Diode Array spectrophotometer. The ink was diluted to have a pigment concentration of 0.005%. A spectrophotometric measurement of the UV-VIS-NIR absorption spectrum of the diluted ink was performed in transmission-mode with a double beam-spectrophotometer using the settings of Table 1. Quartz cells with a path length of 10 mm were used and water was chosen as a blank.

TABLE 1

| Mode | Absorbance | |
|---|---|---|
| Wavelength range | 240-1100 | nm |
| Slit width | 3.0 | nm |
| Scan interval | 1.0 | nm |

| | |
|---|---|
| Detector | photo-multiplier (UV-VIS) |
| | PbS-detektor (NIR |

Efficient pigmented inkjet inks exhibiting a narrow absorption spectrum and a high maximum absorbance have a value for SSF of at least 30.

### 2. Dispersion Stability

The dispersion stability was evaluated by comparing the SSF before and after a heat treatment of one week at 80° C. Pigmented inkjet inks exhibiting good dispersion stability have a SSF after heat treatment still larger than 30 and preferably a % reduction in SSF smaller than 20%.

### 3. Polymer Analysis

All polymers have been characterized with gel permeation chromatography (GPC) and nuclear magnetic resonance spectroscopy (NMR). Random or block copolymers were analyzed with NMR by dissolving them in a deuterated solvent. For 1H-NMR±20 mg polymer was dissolved in 0.8 mL CDCl3 or DMSO-d6 or acetonitrile-d3 or D₂O (with or without NaOD addition). Spectra were recorded on a Varian Inova 400 MHz instrument equipped with an ID-probe. For 13C-NMR±200 mg polymer was dissolved in 0.8 mL CDCl3 or DMSO-d6 or acetonitrile-d3 or D₂O (with or without NaOD addition). Spectra were recorded on a Varian Gemini2000 300 MHz equipped with a SW-probe.

Mn, Mw, Mz and polydispersity (pd) values were measured using gel permeation chromatography. For polymers dissolvable in organic solvents PL-mixed B columns (Polymer Laboratories Ltd) were used with THF+5% acetic acid as mobile phase using polystyrene with known molecular weights as calibration standards. These polymers were dissolved in the mobile phase at a concentration of 1 mg/mL. For polymers dissolvable in water PL Aquagel OH-60, OH-50, OH-40 and/or OH-30 (Polymer Laboratories Ltd) column combinations were used depending on the molecular weight region of the polymers under investigation. As mobile phase water/methanol mixtures adjusted to pH 9.2 with, e.g., disodiumhydrogen phosphate were used with or without the addition of neutral salts, e.g., sodium nitrate. As calibration standards polyacrylic acids with known molecular weights were used. The polymers were dissolved in either water or water made basic with ammonium hydroxide at a concentration of 1 mg/mL. Refractive index detection was used.

An example is now given to illustrate the calculation of the average composition of a random (=statistical) copolymer P(MAA-c-EHA).

The Mn of the copolymer was determined with GPC to be 5000. The molar percentage of each monomer type by NMR was determined to be: 45 mol % MAA and 55 mol % EHA.

### Calculation:

(0.45×MMAA)+(0.55×MEHA)=140.09

5000/140.09=total number of monomeric units in average polymer chain=36
Average number of MAA units=0.45×(5000/140.09)=16 units
Average number of EHA units=0.55×(5000/140.09)=20 units
Thus, the average composition is P(MAA16-c-EHA20).

### 4. Particle Size

The particle size of pigment particles in pigmented inkjet ink was determined by photon correlation spectroscopy at a wavelength of 633 nm with a 4 mW HeNe laser on a diluted sample of the pigmented inkjet ink. The particle size analyzer used was a Malvern™ nano-S available from Goffin-Meyvis.

The sample was prepared by addition of one drop of ink to a cuvet containing 1.5 mL water and mixed until a homogenous sample was obtained. The measured particle size is the average value of 3 consecutive measurements consisting of 6 runs of 20 seconds. For good ink jet characteristics (jetting characteristics and print quality) the average particle size of the dispersed particles is preferably below 150 nm.

### Example 1

This example illustrates the high quality, i.e., a large color gamut (high SSF), and the high stability of a pigmented magenta inkjet ink containing a long aliphatic chain (meth)acrylate.

### Synthesis of Statistical Copolymers

Polymeric dispersants POL-1 to POL-8 with different compositions were synthesized. The polymeric dispersants POL-6 to POL-8 contained a long aliphatic chain methacrylate (LCMA).

TABLE 2

| Amount | | | | | | | | |
|---|---|---|---|---|---|---|---|---|
| (g) | POL-1 | POL-2 | POL-3 | POL-4 | POL-5 | POL-6 | POL-7 | POL-8 |
| AA | — | — | — | — | 14.24 | 14.94 | 14.94 | 11.25 |
| MAA | 3.37 | 1.74 | 18.02 | 8.53 | — | — | — | — |
| MMA | — | — | — | — | 5.65 | 5.74 | 5.74 | 4.26 |
| BnMA | 4.28 | 5.60 | 20.02 | — | — | — | — | — |
| BuMA | 3.33 | — | — | 14.96 | — | — | — | — |
| BuA | — | — | — | — | 19.10 | 20.33 | 20.33 | 15.45 |
| MPEGMA | — | 2.48 | 20.93 | 14.31 | — | — | — | — |
| EHA | — | — | 19.83 | — | — | — | — | — |
| STY | — | — | 11.21 | 7.21 | — | — | — | — |
| LCMA | — | — | — | — | — | 3.99 | 3.99 | 8.03 |
| Wako | 0.10 | 0.03 | 0.52 | 0.67 | 0.37 | 0.10 | 0.41 | 0.33 |
| V601 | | | | | | | | |
| α-MSTY | 0.10 | 0.03 | 9.52 | — | 0.38 | 0.10 | 0.42 | 0.34 |
| IPA | 24.37 | 21.79 | 208.96 | 104.33 | 90.25 | 104.79 | 104.18 | 90.34 |

The synthesis is exemplified for the polymeric dispersant POL-6, i.e., the statistical copolymer P(AA-c-BuA-c-MMA-c-LCMA).

In a 250 ml flask the following ingredients were successively added:

0.10 g WAKO™ V601 initiator, 104.79 g IPA, 14.94 g acrylic acid, 20.33 g butylacrylate, 5.74 g methyl methacrylate, 3.99 g decyl methacrylate and
0.10 g α-methylstyrene dimer. After addition to the flask the mixture was stirred and nitrogen gas was bubbled through the solution for 30 min. Then the reaction mixture was heated to 80° C. at which temperature it was kept for 20 hours. After 20 hours, the reaction mixture was cooled to 20° C., precipitated into ice-water (1500 ml) and filtrated. The residue was dried for 48 hours at 35° C. under vacuum. This resulted in 27.38 g of a white solid (ca. 60% yield).

The characterization of the polymeric dispersant POL-6 using GPC resulted in Mn=2387 and Mw/Mn=2.29 and using 13C-NMR the composition was analyzed to consist of: 44 mol % AA, 36 mol % BuA, 15 mol % MMA, and 5 mol % LCMA.

The polymeric dispersants POL-1 to POL-5, POL-7 and POL-8 were prepared in a similar way as described for POL-6 but by using the amounts given by Table 2. The resulting composition of the polymeric dispersant is given by Table 3 and was determined by using 13C-NMR for the polymeric dispersants POL-3, POL-4 and POL-6 to POL-8 and by using 1H-NMR for the polymeric dispersants POL-1, POL-2 and POL-5.

TABLE 3

| mol % | POL-1 | POL-2 | POL-3 | POL-4 | POL-5 | POL-6 | POL-7 | POL-8 |
|---|---|---|---|---|---|---|---|---|
| AA | — | — | — | — | 49 | 44 | 45 | 40 |
| MAA | 43 | 31 | 26 | 35 | — | — | — | — |
| MMA | — | — | — | — | 14 | 15 | 15 | 16 |
| BnMA | 31 | 59 | 36 | — | — | — | — | — |
| BuMA | 26 | — | — | 31 | — | — | — | — |
| BuA | — | — | — | — | 37 | 36 | 35 | 32 |
| MPEGMA | — | 10 | 8 | 11 | — | — | — | — |
| EHA | — | — | 11 | — | — | — | — | — |
| Sty | — | — | 19 | 23 | — | — | — | — |
| LCMA | — | — | — | — | — | 5 | 5 | 12 |
| Yield | 10.98 | 9.82 | 94.54 | 4.05 | 34.6 | 27.38 | 34.21 | 30.69 |
| (g) | | | | | | | | |
| Mn | 27191 | 65739 | 23790 | 24653 | 4918 | 6737 | 6685 | 8037 |
| Mw/Mn | 2.67 | 5.04 | 2.27 | 2.50 | 2.68 | 2.95 | 2.38 | 2.25 |

EDAPLAN™ 482 available from MÜNZING CHEMIE was used as polymeric dispersant POL-9. EDAPLAN™ 482 contained about 6 mol % of a long aliphatic chain methacrylate (LCMA).

### Preparation of the Pigmented Magenta Inkjet Ink

Each of the pigmented magenta inkjet inks was prepared by the same two steps. In a first step, a concentrated aqueous pigment dispersion was made by mixing the pigment Inkjet Magenta™, the polymeric dispersant and water in a 60 mL flask according to the formulation of Table 4.

TABLE 4

| | Concentration |
|---|---|
| Component | (wt %) |
| Inkjet Magenta ™ | 5 |
| Polymeric | 3 |
| dispersant | |
| Water | 92 |

Each concentrated aqueous pigment dispersion was subjected to a wet dispersion treatment using a roller mill and 0.04 mm yttrium stabilized zirconium beads YTZ™ Grinding Media (available from TOSOH Corp.). The flask is filled to half its volume with the grinding beads and put onto the roller mill. The speed is set at 150 rotations per minute for three days. After milling, the dispersion is separated from the beads using a filter cloth.

The concentrated aqueous pigment dispersion served as the basis for the preparation of the pigmented inkjet ink. The inkjet inks were prepared by mixing the components according to the general formulation of Table 5 expressed in weight % based on the total weight of the ink.

TABLE 5

| | Magenta ink |
|---|---|
| Component | (wt %) |
| Inkjet Magenta ™ | 2.7 |
| Polymeric | 1.6 |
| dispersant | |
| 1,2-propanediol | 21.0 |
| Glycerol | 7.0 |
| Water | to complete 100.0 |
| | wt % |

### Evaluation

Using the above method, the comparative pigmented inkjet inks COMP-1 to COMP-6 and the inventive pigmented inkjet inks INV-1 to INV-3 were prepared according to Table 6. The spectral separation factor (SSF) was determined for each sample directly after preparation and was determined again after a severe heat treatment of 1 week at 80° C. The results are listed in Table 6.

TABLE 6

| | | | % Reduction in |
|---|---|---|---|
| | Polymeric | | SSF after 7 days |
| Inkjet Ink | Dispersant | SSF | at 80° C. |
| COMP-1 | POL-1 | 18 | 0% |
| COMP-2 | POL-2 | 3 | 0% |
| COMP-3 | POL-3 | 7 | 0% |
| COMP-4 | POL-4 | 18 | 0% |
| COMP-5 | POL-5 | 54 | 30% |
| INV-1 | POL-6 | 57 | 0% |
| INV-2 | POL-7 | 60 | 0% |
| COMP-6 | POL-8 | 16 | 0% |
| INV-3 | POL-9 | 72 | 0% |

From Table 6, it is clear that the comparative pigmented inkjet inks COMP-1 to COMP-5, prepared with a statistical copolymer free of a long aliphatic chain methacrylate, were low quality inkjet inks. Either the pigmented inkjet ink exhibited a small SSF (less than 30) or otherwise exhibited a high SSF but having no stability after an aging test of one week at 80° C. The inventive pigmented inkjet inks INV-1 to INV-3 combined high image quality and high dispersion stability. However, pigmented inkjet inks containing the polymeric dispersant POL-8 with a composition containing more than 10 mol % of decyl methacrylate exhibited again a poor image quality.

### Example 2

This example illustrates that the polymeric dispersants containing a long aliphatic chain (meth)acrylate not only have excellent dispersion stability but also are less sensitive to changes in the composition of the dispersion medium of the pigmented inkjet ink. These changes can occur when evaporation of volatile components in the inkjet ink is allowed, for example, in an open ink container or at the nozzle plate of the inkjet printhead. 1,2-Hexanediol was used to alter the composition in dispersion medium of the pigmented inkjet ink. The comparative pigmented inkjet inks COMP-7 and COMP-8 and the inventive pigmented inkjet inks INV-4 and INV-5 were prepared by dilution with 5 wt % of 1,2-hexanediol of the comparative pigmented inkjet inks COMP-5 and COMP-6 respectively the inventive pigmented inkjet inks INV-1 and INV-2 prepared for Example 1.

### Evaluation

The average particle size for each of the comparative pigmented inkjet inks COMP-5 to COMP-8 and the inventive pigmented inkjet inks INV-1, INV-2, INV-4 and INV-5 were determined and are given by Table 7.

TABLE 7

| | |
|---|---|
| | Diluted with |
| Undiluted | 1,2-hexanediol |

| Polymeric | Inkjet | Particle | Inkjet | Particle |
|---|---|---|---|---|
| Dispersant | ink | size (nm) | ink | size (nm) |
| POL-5 | COMP-5 | 124 | COMP-7 | 185 |
| POL-6 | INV-1 | 141 | INV-4 | 123 |
| POL-7 | INV-2 | 135 | INV-5 | 117 |
| POL-8 | COMP-6 | 248 | COMP-8 | 290 |

From Table 7 it is clear that only the inventive pigmented inkjet inks INV-1, INV-2, INV-4, and INV-5 exhibited average particle sizes of the dispersed particles smaller than 150 nm in both dispersion media having low or high concentration of 1,2-hexanediol.

### Example 3

This example shows a pigmented inkjet ink set wherein inks including a polymeric dispersant according to preferred embodiments of the present invention exhibit excellent dispersion quality.

### Inkjet Ink Set

The aqueous pigmented inkjet ink set consists of 7 color inks, i.e., cyan, yellow, magenta, and black full density inks, completed with three light density inks, namely light cyan, light magenta, and light black inks.

The inkjet ink compositions were prepared in the same way as in EXAMPLE 1 and are the inkjet ink compositions in wt % based on the total weight of the ink are given in Table 8 and Table 9. The dense ink and the light ink of the same color were obtained from diluting the same concentrated pigment dispersion with different amounts of ink carrier liquid.

TABLE 8

| | | | | Light |
|---|---|---|---|---|
| | Cyan | Light | Magenta | Magenta |
| wt % of component | Ink | Cyan Ink | Ink | Ink |
| C.I. Pigment Blue | 1.50 | 0.75 | — | — |
| 15:3 | | | | |
| C.I. Pigment Red | — | — | 2.70 | 0.75 |
| 122 | | | | |
| Joncryl ™ 8078 | 4.70 | 2.34 | — | — |
| Edaplan ™ 482 | — | — | 3.16 | 0.88 |
| 1,2-hexanediol | 5.00 | 5.00 | 5.00 | 5.00 |
| Glycerine | 20.00 | 20.00 | 20.00 | 20.00 |
| Proxel Ultra 5 | 0.04 | 0.01 | 0.07 | 0.02 |
| Water | 68.76 | 71.90 | 69.07 | 73.35 |

TABLE 9

| | Yellow | Black | Light Black |
|---|---|---|---|
| wt % of component | Ink | Ink | ink |
| C.I. Pigment | 5.33 | — | — |
| Yellow 74 | | | |
| C.I. Pigment | — | 3.00 | 0.75 |
| Black 7 | | | |
| Edaplan ™ 482 | 6.23 | 3.51 | 0.88 |
| 1,2-hexanediol | 5.00 | 5.00 | 5.00 |
| Glycerine | 20.00 | 20.00 | 20.00 |
| Proxel Ultra 5 | 0.14 | 0.08 | 0.08 |
| Water | 63.30 | 68.41 | 73.29 |

The spectral separation factor (SSF) was determined for each ink of the ink set. The results are listed in Table 10.

TABLE 10

| Inkjet ink | SSF |
|---|---|
| Cyan ink | 69 |
| Light Cyan ink | 69 |
| Magenta ink | 61 |
| Light Magenta ink | 69 |
| Yellow ink | 134 |

The dispersion quality of black inkjet inks was evaluated by particle size measurements. The average particle size measured with a Brookhaven Instruments Particle Size BI90plus based upon the principle of dynamic light scattering. The inkjet ink was diluted between 2,000 and 20,000 times and 5 runs at 23° C. were measured at a 90° angle and 635 nm wavelength with the BI90plus set to graphics=correction function.

The black pigments were finely divided in both the full density and the light density black inkjet inks with an average particle size for the Black ink of 81 nm and for the Light Black ink of 84 nm.

Images printed with the inkjet ink set were of excellent quality.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A pigmented inkjet ink comprising:
a pigment; and
a polymeric dispersant; wherein
the polymeric dispersant is a statistical copolymer including between 3 mol % and 11 mol % of a long aliphatic chain (meth)acrylate; and
the long aliphatic chain contains at least 10 carbon atoms.

12. The pigmented inkjet ink according to claim 11, wherein the long aliphatic chain (meth)acrylate is decyl (meth)acrylate.

13. The pigmented inkjet ink according to claim 11, wherein the polymeric dispersant further comprises at least 25 mol % n-butyl (meth)acrylate, at least 25 mol % (meth)acrylic acid, and/or at least 5 mol % methyl (meth)acrylate.

14. The pigmented inkjet ink according to claim 11, wherein the polymeric dispersant has a Mw smaller than 50000.

15. The pigmented inkjet ink according to claim 11, wherein the pigment is a quinacridone.

16. The pigmented inkjet ink according to claim 15, wherein the quinacridone is C.I. Pigment Red 122, C.I. Pigment Violet 19, or a mixture thereof.

17. The pigmented inkjet ink according to claim 11, wherein the inkjet ink is a radiation curable inkjet ink.

18. An inkjet ink set comprising at least one pigmented inkjet ink according to claim 11.

19. A method for manufacturing a pigmented inkjet ink comprising the steps:
a) providing a statistical copolymer including between 3 mol % and 11 mol % of a long aliphatic chain (meth)acrylate, wherein the long aliphatic chain contains at least 10 carbon atoms as a polymeric dispersant;
b) providing a pigment; and
c) precipitating or milling the pigment in a dispersion medium in the presence of the polymeric dispersant.
